(19) United States
(12) Patent Application Publication
(10) Pub. No.: US 2016/0050440 A1
(43) Pub. Date: Feb. 18, 2016

(54) LOW-COMPLEXITY DEPTH MAP ENCODER WITH QUAD-TREE PARTITIONED COMPRESSED SENSING

(71) Applicants: Ying Liu, North Tonawanda, NY (US); Joohee Kim, Oak Brook, IL (US)

(72) Inventors: Ying Liu, North Tonawanda, NY (US); Joohee Kim, Oak Brook, IL (US)

(21) Appl. No.: 14/827,916

(22) Filed: Aug. 17, 2015

Related U.S. Application Data
(60) Provisional application No. 62/038,011, filed on Aug. 15, 2014.

(51) Int. Cl. H04N 19/597; H04N 13/00; H04N 19/129

(52) U.S. Cl. CPC H04N 19/597; H04N 19/129; H04N 13/0048

(57) ABSTRACT

A variable block size compressed sensing (CS) method for high efficiency depth map coding. Quad-tree decomposition is performed on a depth image to differentiate irregular uniform and edge areas prior to CS acquisition. To exploit temporal correlation and enhance coding efficiency, the quad-tree based CS acquisition is further extended to inter-frame encoding, where block partitioning is performed independently on the I frame and each of the subsequent residual frames. At the decoder, pixel domain total-variation minimization is performed for high quality depth map reconstruction.

### CROSS REFERENCE TO RELATED APPLICATION

This application claims the benefit of U.S. Provisional Patent Application Ser. No. 62/038,011, filed on 15 Aug. 2014. The co-pending Provisional Patent Application is hereby incorporated by reference herein in its entirety and is made a part hereof, including but not limited to those portions which specifically appear hereinafter.

### BACKGROUND OF THE INVENTION

This invention relates generally to depth map encoding and, more particularly, to a method of encoding where compression is achieved with low computational cost.

Recent advance in display and camera technologies has enabled three-dimensional (3-D) video applications such as 3-D TV and stereoscopic cinema. In order to provide the “look-around” effect that audiences expect from a realistic 3-D scene, a vast amount of multi-view video data needs to be stored or transmitted, leading to the desire of efficient compression techniques. One proposed solution is to encode two views of the same scene captured from different viewpoints along with the corresponding depth (disparity) map. With texture video sequences and depth map sequences, an arbitrary number of intermediate views can be synthesized at the decoder side using depth image-based rendering (DIBR) techniques. Depth maps, therefore, are generally considered as an essential coding target for 3-D video applications.

Typically, depth maps are characterized by irregular piecewise smooth areas separated by sharp object boundaries, with very limited texture. To efficiently compress such images, traditional methods focus on constructions of linear functions to effectively represent smooth areas or transforms that are adapted to edges. However, existing methods always apply CS to equal-size depth map blocks. Since depth maps contain large irregular shape of smooth areas separated by sharp edges that represent object boundaries, such equal block-size compression leads to redundant CS operations (i.e., redundant linear transforms, or redundant multiplication operations) on the irregular smooth areas, which severely restricts the coding efficiency in terms of compression ratio and encoding time. Thus there is a continuing need for improved compression methods.

### SUMMARY OF THE INVENTION

A general object of the invention is to provide a low-complexity depth map encoder where depth map compression is achieved with very low computational cost. Because power consumption is proportional to the encoder complexity, such depth map encoder is highly desirable in low-cost, low-power multi-view video sensors to prolong the sensor battery life.

The general object of the invention can be attained, at least in part, through a method of compressing and reconstructing depth images sequences from multi-view video sensors. In embodiments of this invention, the method is fully automated and comprises: recursively partitioning and classifying depth images of at least two corresponding multi-view videos into a plurality of smooth blocks of varying size and a plurality of edge blocks; encoding each smooth block as a function of block pixel intensity; encoding each edge block using compressed sensing; reconstructing the smooth blocks and the edge blocks into reconstructed macro blocks; and forming depth image sequences from the reconstructed macro blocks for the at least two corresponding multi-view videos. The recursively partitioning and classifying can comprise: partitioning the depth images of at least two corresponding multi-view videos into a plurality of non-overlapping macro blocks; classifying each macro block as a smooth block or an edge block; partitioning each of the edge blocks into a plurality of sub-blocks; classifying each sub-block as a further smooth block or a further edge block; and repeating the partitioning and classifying of each further edge block until the partitioning has reached a predetermined maximum level.

In embodiments of this invention, the target depth images to be compressed, also known as “depth maps”, are essential in the popular depth image-based rendering (DIBR) techniques in 3D video applications. Typically, the encoder compresses several views of the same scene captured from different viewpoints along with the corresponding depth (disparity) maps, and the decoder reconstructs them and then synthesizes intermediate views to provide the “look-around” effect that audiences expect from a realistic 3-D scene. Embodiments of the invention include forming three-dimensional depth images sequences from the macro blocks for the at least two corresponding multi-view videos. The method is particularly useful for compressing depth information in real time from a plurality of video sensors, and transmitting the compressed depth information to a remote processor for reconstruction and multi-view synthesis.

To avoid the redundant CS operations on the depth maps, embodiments of the invention partitions depth maps into the smooth blocks of variable sizes and edge blocks of one fixed size. Since each of these smooth blocks has very small pixel intensity standard derivation, they can be encoded with 8-bit approximation, or equivalent, with negligible distortion. On the other hand, edge blocks have complex details and cannot be encoded with a single value approximation; therefore the encoder applies CS to encode the edge blocks. As a result, the computational burden (multiplication operations) comes from only the edge blocks. Compared to existing equal block-size CS based depth map encoders, the invented encoder highly reduces the encoding complexity, as well as improves the rate-distortion (R-D) performance of the compressed depth maps.

In some embodiments according to this invention, a CS based variable block size encoder is developed for efficient depth map compression. To avoid redundant CS acquisition of large irregular uniform areas, a simple top-down quad-tree decomposition algorithm is proposed to partition a depth map into uniform blocks of variable sizes and small blocks containing edges. Lossless 8-bit compression is then applied to each of the uniform blocks and only the edge blocks are encoded by CS and subsequent entropy coding. Such variable block size encoder is then extended to inter-frame encoding, where the quad-tree decomposition is independently applied to the I frame and subsequent residual frames in a group of pictures (GOP) of I-P-P-P structure. At the decoder, pixel-domain total-variation minimization is applied to the de-quantized CS measurements (or sub-sampled 2D-DCT coefficients) for edge block reconstruction.

The method and system of this invention is desirably automatically executed or implemented on and/or through a computing platform. Such computing platforms generally include one or more processors for executing the method steps stored as coded software instructions, at least one recordable medium for storing the software and/or video data received or produced by method, an input/output (I/O) device, and a network interface capable of connecting either directly or indirectly to a video camera and/or the Internet or other network.

Other objects and advantages will be apparent to those skilled in the art from the following detailed description taken in conjunction with the appended claims and drawings.

### BRIEF DESCRIPTION OF THE DRAWINGS

FIG. 1 is a block diagram illustrating a quad-tree partitioned intra-frame CS encoder according to embodiments of this invention.

FIG. 2 illustrates quad-tree decomposition according to embodiments of this invention.

FIG. 3 is a block diagram illustrating an intra-frame TV minimization decoder according to embodiments of this invention.

FIG. 4 is a block diagram illustrating an inter-frame quad-tree partitioned CS encoder according to embodiments of this invention.

FIG. 5 is a block diagram illustrating an inter-frame CS decoder according to embodiments of this invention.

FIG. 6 shows different reconstructions of an 8th frame of the example Kendo video clip view 1's depth map sequence: (a) original Kendo depth image; (b) magnified view of the marked area; (c) marked area with QCS, T=20 encoded at 0.073 bits per pixel (bpp) and reconstructed at 46.4534 dB of PSNR; (d) with ECS, T=20 encoded at 0.1475 bpp and reconstructed at 44.4933 dB of PSNR; and (e) with Intra GBT encoded at 0.233 bpp and reconstructed at 44.1326 dB of PSNR.

FIG. 7 shows different reconstructions of a 2nd frame of the example Balloons video clip view 1's depth map sequence: (a) original Balloons depth image; (b) magnified view of the marked area; (c) marked area coded with QCS, T=20 encoded at 0.1160 bpp and reconstructed at 46.0555 dB of PSNR; (d) with ECS, T=20 encoded at 0.1495 bpp and reconstructed at 41.8531 dB of PSNR; and (e) with Intra GBT encoded at 0.2725 bpp and reconstructed at 41.2059 dB of PSNR.

FIG. 8 is a graph summarizing rate-distortion studies on the synthesized view 2 of the Kendo sequence.

FIG. 9 is a graph summarizing rate-distortion studies on the synthesized view 2 of the Balloons sequence.

### DESCRIPTION OF THE INVENTION

The present invention provides a low-complexity depth map encoder with very low computational cost. A foundation of the invented encoder is a compressed sensing (CS) technique, which enables fast compression of sparse signals with just a few linear measurements, and reconstructs them using nonlinear optimization algorithms. Since depth maps contain large piece-wise smooth areas with edges that represent object boundaries, they are considered highly sparse signals. Hence, a low-complexity depth map encoder can be designed using CS technique.

Embodiments of this invention partition depth maps into “smooth blocks” of variable sizes and edge blocks of one fixed size. Since each of these smooth blocks has very small pixel intensity standard derivation, they can be encoded with 8-bit approximation with negligible distortion. On the other hand, edge blocks have complex details and cannot be encoded with a single value approximation; therefore our encoder applies CS to encode the edge blocks. As a result, the computational burden (multiplication operations) comes from only the edge blocks. Compared to existing equal block-size CS based depth map encoders, the encoder according to some embodiments of this invention highly reduces the encoding complexity, as well as improves the rate-distortion (R-D) performance of the compressed depth maps.

The low-complexity depth map encoder, according to some embodiments of this invention, is suitable for a broad range of 3-D applications where depth map encoding is needed for multi-view synthesis. Examples include live sport game broadcasting, wireless video surveillance networks, and 3-D medical diagnosis systems. In many applications according to different embodiments of this invention, it is economic to deploy low cost multi-view video sensors all around the scene of interest and capture the depth information in real-time from different viewpoints, then the compressed data can be transmitted to powerful processing unit for reconstruction and multi-view synthesis such as 3-D TV, or central servers where high complexity decoding and view synthesis are affordable due to the high computation capability.

In some embodiments of this invention, the low-complexity depth map encoder can be deployed in power-limited consumer electronics such as personal camcorders, cell phones, and tablets, where large amounts of multi-view information can be captured/compressed and stored in these hand-held devices in a real-time basis, e.g., when people are travelling, or in conferences, seminars, and processed offline with powerful decoding systems.

The depth map encoder, according to some embodiments of this invention, has low battery consumption, particularly suitable to be installed in wireless multi-view cameras, large-scale wireless multi-media sensor networks, and other portable devices where battery replacement is difficult.

In embodiments of this invention, a low-complexity depth map encoder is based on quad-tree partitioned compressed sensing, in which compressed sensing technique is applied to compress edge blocks. To obtain good decoding of these blocks, in some embodiments of this invention, sparsity constrained reconstruction shall be used at the decoder. In some embodiments of this invention, first described is an intra-frame encoder and the corresponding spatial total-variation minimization (sparsity constraint of the spatial gradient) based decoder, and then extending the framework to an inter-frame encoder and decoder.

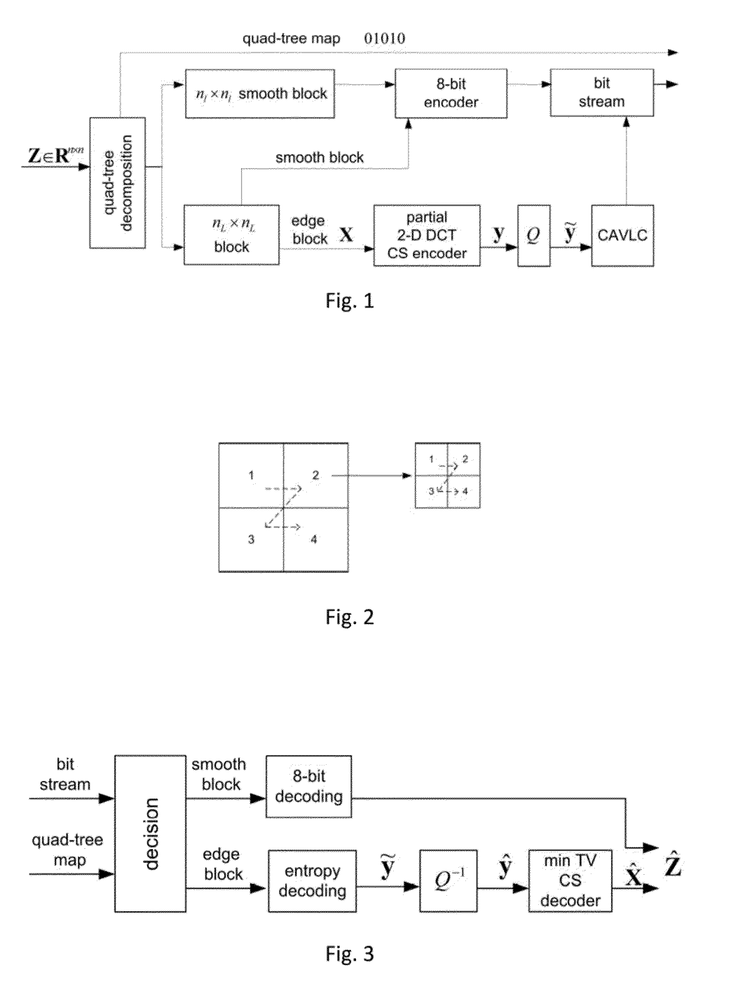

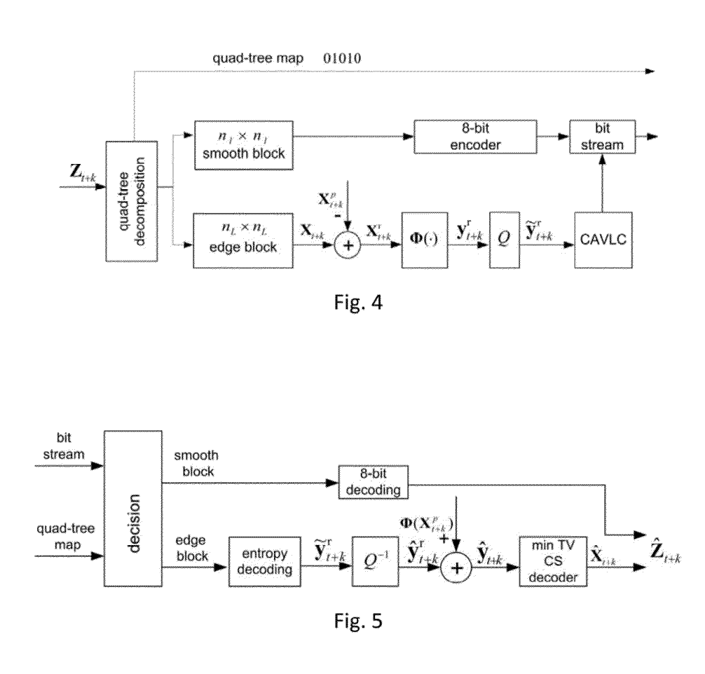

In some embodiments of this invention, in the intra-frame encoder block diagram, for example as shown in FIG. 1, each frame is virtually partitioned into non-overlapping macro blocks of size n×n. A simple L-level top-down quad-tree decomposition is then applied to each macro block Z ε R^{n×n} independently to partition it into uniform blocks of size

$$\frac{n}{{2}^{l - 1}} \times \frac{n}{{2}^{l - 1}} ,$$

l ε {1, 2, . . . , L} and edge blocks of size

$$\frac{n}{{2}^{L - 1}} \times \frac{n}{{2}^{L - 1}} .$$

In some embodiments of this invention, the fast speed of the proposed CS depth map encoder relies on the quad-tree decomposition, for example as illustrated in FIG. 2. For each macro block Z, the proposed quad-tree decomposition starts from level l=1 corresponding to the macro block of size n×n, if the standard deviation of the macro block is smaller than a pre-defined threshold, then it is classified as a smooth block; otherwise, it is considered as an edge block. The edge block is partitioned into four sub-blocks and the block classification procedure is repeated for each of the sub-blocks, for example, in the order indicated by the arrows shown in FIG. 2. In some embodiments of this invention, while the edge sub-blocks are further partitioned, nothing needs to be done for smooth sub-blocks. Such recursive block-partitioning is performed until a smooth block is found or the quad-tree partitioning level has reached a predetermined maximum level l=L.

At level-l of the quad-tree partitioning, if Xₗ is a smooth block, the encoder transmits a “0” to indicate Xₗ is not partitioned, otherwise, the encoder transmits a “1” to indicate Xₗ is partitioned. The resulting bit stream is transmitted as the “quad-tree map” to inform the decoder of the decomposition structure for successful decoding.

In some embodiments of this invention, each uniform smooth block can be losslessly encoded using, for example, 8-bit representation that represents its average pixel intensity, and CS is performed on each edge block

$$X ∈ {R}^{\frac{n}{{2}^{L - 1}} \times \frac{n}{{2}^{L - 1}}}$$

in the form of y=Φ(X), where the sensing operator Φ(·) is equivalent to sub-sampling the 2D-DCT coefficients of the lowest frequency after zigzag scan. Then, the resulting measurement vector y ε R^{P} can be processed by a scalar quantizer with a certain quantization parameter (QP), and the quantized indices are entropy encoded using context adaptive variable length coding (CAVLC) as implemented in A. A. Muhit, et al. “Video Coding using Elastic Motion Model and Larger Blocks,” IEEE Trans. Circuits Syst. Video Technol., vol. 20, no. 5, pp. 661-672, May 2010, and transmitted to the decoder.

In some embodiments of this invention, an intra-frame decoder is used to reconstruct, desirably independently, each macro-block. In some embodiments of this invention, as described in FIG. 3, the decoder first reads the bit stream along with the binary quad-tree map to identify smooth and edge blocks. For smooth blocks, simple 8-bit decoding can be implemented. In some embodiments of this invention, for edge blocks, the decoder performs entropy decoding to obtain the quantized partial 2D-DCT CS measurements \tilde{y}. The elements of \tilde{y} are then de-quantized to form the vector \tilde{y}.

In one embodiment of this invention, reconstruction of edge blocks is performed via total-variation (TV) minimization. Since depth map blocks containing edges have sparse spatial gradients, they can be reconstructed via pixel-domain 2D (or spatial) total-variation (TV) minimization in the form of:

$${X}^{⋒} - arg {min}_{X} {TV}_{2 D} ( X ) , \\ subject to {‖ \hat{y} - Φ ( X ) ‖}_{{l}_{2}} \leq ɛ .$$

The reconstructed uniform blocks and edge blocks can then be regrouped to form the decoded macro block \hat{Z}.

So far, we have carried out the quad-tree based CS encoding for only intra frames. To exploit temporal correlation among successive frames, the algorithm is extended to inter-frame encoding. In some embodiments of this invention, for inter-frame coding, the sequences of depth images are divided into groups of pictures (GOP) of an I-P-P-P structure. The I frame is encoded and decoded using the intra-frame encoder/decoder described above. To encode the k^{th}P frame after the I frame, the quad-tree decomposition is performed first on macro block Zₜ₊ₖ in the P frame, then smooth blocks are encoded in the same way as in I frames, and an edge block Xₗ is first predicted by the decoded block Xₗ^{p} in the same location in previous frame and the residual block Xₗ^{r}=Xₗ−Xₗ^{p} is encoded with CS, followed by quantization and entropy coding.

In some embodiments of this invention, for reconstruction, the smooth blocks can be recovered via 8-bit decoding. For an edge block, the CS measurement vector ŷₜ₊ₖ is generated by summing the de-quantized residual CS measurements ŷₜ₊ₖ^{r} and the CS measurements of the reference block Φ(Xₜ₊ₖ^{p}), and the same pixel-domain TV minimization algorithm used for the I frame edge block reconstructions is applied to reconstruct the P frame pixel block Xₜ₊ₖ in the form of:

$${{X}^{⋒}}_{t + k} - arg {min}_{X} {TV}_{2 D} ( X ) , \\ subject to \text{:} {‖ {\hat{y}}_{t + k}^{r} + Φ ( {\hat{X}}_{t} ) - Φ ( X ) ‖}_{{l}_{2}} \leq ɛ .$$

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

Experiments were conducted to study the performance of the proposed CS depth map coding system by evaluating the R-D performance of the synthesized view. Two test video sequences, Balloons and Kendo, with a resolution of 1024×768 pixels, were used. For both video sequences, 40 frames of the depth maps of view 1 and view 3 were compressed using the proposed quad-tree partitioned CS encoder, and the reconstructed depth maps at the decoder were used to synthesize the texture video sequence of view 2 with the View Synthesis Reference Software (VSRS) described in Tech. Rep. ISO/IEC JTC1/SC29/WG11, March 2010.

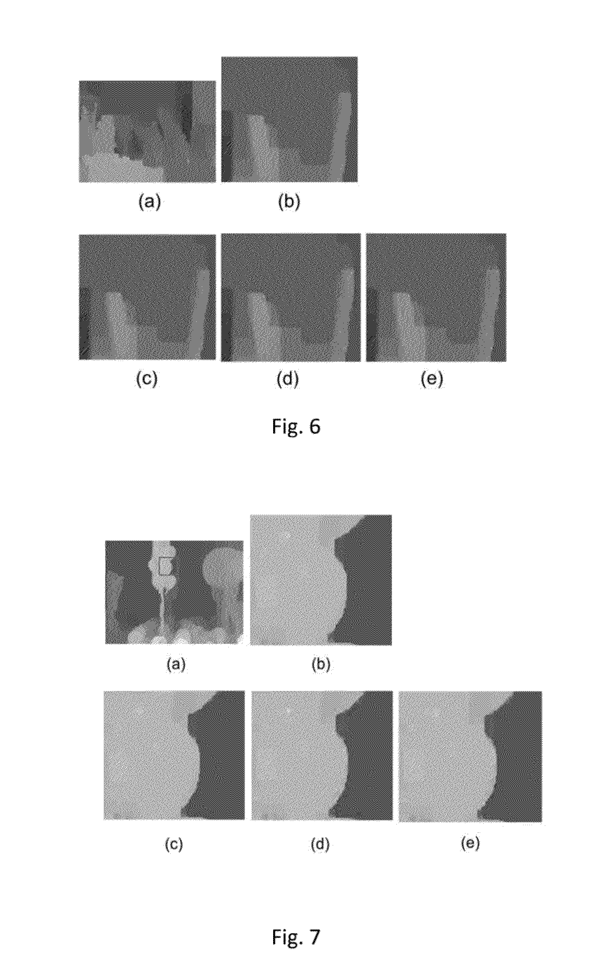

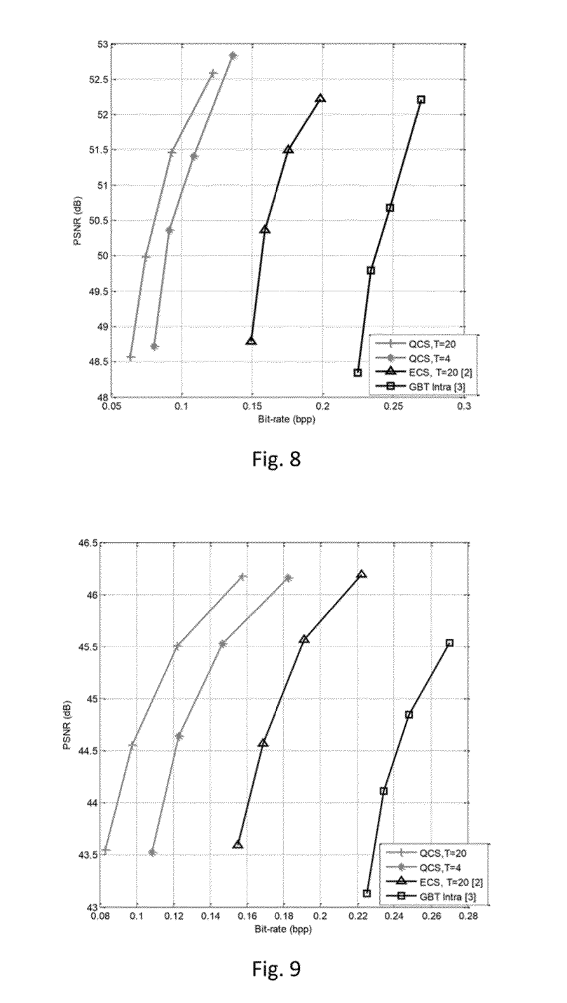

To evaluate the performance of the invented encoder, the perceptual quality of the decoded depth maps are shown in FIGS. 6 and 7, and the R-D performance of the synthesized views are shown in FIGS. 8 and 9. In addition, the encoder complexity was analyzed below. In these experiments, the inter-frame encoding structure was adopted for the invented quad-tree partitioned CS (QCS) encoder with intra-frame period (GOP size) T=4 and T=20. The result was compared with two existing CS based low-complexity depth map encoders: an inter-frame equal block-size CS encoder (ECS) (Y. Morvan et al., “Platelet-based images,” in Proc. SPIE Stereoscopic Displays and Virtual Reality Systems XIII, vol. 6055, January 2006) coding of depth maps for the transmission of multi-view, and an intra-frame CS encoder with graph-based transform (Intra GBT) (M. Maitre et al., “Depth and depth-color coding using shape-adaptive wavelets,” J. Vis. Commun. Image R., vol. 21, no. 5-6, pp. 513-522, March 2010) as the sparse basis.

It is important to note that portable document formatting of this document tends to dampen perceptual quality differences between FIG. 6(b)-(e) that are in fact pronounced measured in PSNR, which is the usual attempt to capture average differences quantitatively. Also, the compression rate is measured in bits per pixel (bpp), meaning the average number of bits needed to encode one pixel, and the original depth map before compression has 8 bpp. The distortion is the peak signal-to-noise ratio (PSNR) between the original depth map and the reconstructed depth map measured in dB.

FIG. 8 summarizes the rate-distortion studies on the synthesized view 2 of the Kendo sequence. The bit-rate is the average bpp for encoding the depth map of view 1 and view 3, and the synthesized texture video view 2's PSNR is measured between the view 2 synthesized with the ground-truth depth maps and the view 2 synthesized with the reconstructed depth maps. FIG. 9 summarizes Rate-distortion studies on the synthesized view 2 of the Balloons sequence.

FIGS. 6 and 7 show that the invented QCS encoder outperforms the other two CS based low-complexity depth map encoders in that it offers lower encoding bit rates while achieves higher reconstructed PSNR. FIGS. 8 and 9 show that the invented QCS encoder outperforms the other two CS based low-complexity depth map encoders in that it offers higher synthesized views of PSNR at the same encoding bit rate, or it offers lower encoding bit rate at the same synthesized views of PSNR.

### Encoder Complexity Analysis

The computational burden of the invented quad-tree partitioned CS depth map encoder lies in the compressed sensing of edge blocks after quad-tree decomposition. Forward partial 2D DCT is required to perform CS encoding and backward partial 2D DCT is required to generate the reference block for P frames. In some embodiments of this invention, since depth maps contain large amount of smooth areas, which do not need to be encoded by CS, the complexity of the quad-tree partitioned CS encoder is much less than the equal block-size CS encoder. Table 1, for example, shows the comparison study of the encoder complexity for three depth map encoders. The data are collected from encoding the Balloons video clip view 1's depth map sequence. In some embodiments of this invention, for all encoders, the encoder complexity is measured in the number of multiplication operations needed to encode one frame. Higher complexity means longer encoding time, and more battery consumption.

TABLE 1

| | | Average number of |
|---|---|---|
| | CS ratio | multiplications per frame |
| Complete 2D DCT | N/A | 3145728 |
| ECS | 0.375 | 1179648 |
| QCS | 0.375 | 318336 |

Thus, the invention provides a variable block size CS coding system for depth map compression. To avoid redundant CS acquisition of large irregular uniform areas, a five-level top-down quad-tree decomposition is utilized to identify uniform blocks of variable sizes and small edge blocks. Each of the uniform blocks is encoded losslessly using 8-bit representation, and the edge blocks are encoded by CS with partial 2D-DCT sensing matrix. At the decoder side, edge blocks are reconstructed through pixel domain total-variation minimization. Since the proposed quad-tree decomposition algorithm is based on simple arithmetic, such CS encoder provides significant bit savings with negligible extra computational cost compared to pure CS-based depth map compression in literature. The proposed coding scheme can further enhance the rate-distortion performance when applied to an inter-frame coding structure.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of compressing and reconstructing depth image sequences from multi-view video sensors, comprising:
recursively partitioning and classifying depth images of at least two corresponding multi-view videos into a plurality of smooth blocks of varying size and a plurality of edge blocks;
encoding each smooth block as a function of block pixel intensity;
encoding each edge block using compressed sensing;
reconstructing the smooth blocks and the edge blocks into reconstructed macro blocks; and
forming depth image sequences from the reconstructed macro blocks for the at least two corresponding multi-view videos.

2. The method of claim 1, wherein the recursively partitioning and classifying comprises:
partitioning the depth images of at least two corresponding multi-view videos into a plurality of non-overlapping macro blocks;
classifying each macro block as a smooth block or an edge block;
partitioning each of the edge blocks into a plurality of sub-blocks;
classifying each sub-block as a further smooth block or a further edge block; and
repeating the partitioning and classifying of each further edge block until the partitioning has reached a predetermined maximum level.

3. The method of claim 2, further comprising classifying one of the macro blocks as a smooth block when a standard deviation of the one of the macro blocks is smaller than a predetermined threshold.

4. The method of claim 1, wherein each smooth block is encoded using 8-bit approximation that represents an average block pixel intensity.

5. The method of claim 1, wherein the compressed sensing is performed on each edge block in the form of y=Φ(X), wherein the sensing operator Φ(·) is equivalent to a sub-sampling of 2D-DCT coefficients of the lowest frequency after zigzag scan.

6. The method of claim 1, further comprising processing a measurement vector of the encoded edge blocks by scalar quantizer with a predetermined quantization parameter.

7. The method of claim 1, further comprising reconstructing each macro block with an intra-frame decoder.

8. The method of claim 7, wherein the decoder identifies and decodes the smooth blocks and the edge blocks.

9. The method of claim 8, wherein smooth block decoding comprises 8-bit decoding and edge block decoding comprises entropy decoding.

10. The method of claim 8, wherein edge block decoding comprises pixel domain two dimensional total-variation minimization.

11. The method of claim 1, further comprising regrouping decoded smooth blocks and decoded edge blocks to reconstruct the macro blocks.

12. The method of claim 1, further comprising inter-frame encoding the macro blocks of the depth images for the at least two corresponding multi-view videos.

13. The method of claim 12, further comprising inter-frame decoding of the macro blocks of the depth images for the at least two corresponding multi-view videos.

14. The method of claim 1, further comprising forming three-dimensional images sequences from the macro blocks for the at least two corresponding multi-view videos.

15. The method of claim 1, further comprising:
compressing depth information in real time from a plurality of video sensors;
transmitting the compressed depth information to a remote processor for reconstruction and multi-view synthesis.
